(19) United States
(12) Patent Application Publication
(10) Pub. No.: US 2014/0126535 A1
(43) Pub. Date: May 8, 2014

(54) BSS DERIVED INFORMATION FOR CS TO PS SRVCC

(71) Applicant: TELEFONAKTIEBOLAGET L M ERICSSON (PUBL), Stockholm (SE)

(72) Inventors: John Walter Diachina, Garner, NC (US); Paul Schliwa-Bertling, Ljungsbro (SE); Hakan Palm, Vaxjo (SE); Hakan Axelsson, Linkoping (SE)

(73) Assignee: TELEFONAKTIEBOLAGET L M ERICSSON (PUBL), Stockholm (SE)

(21) Appl. No.: 14/010,876

(22) Filed: Aug. 27, 2013

Related U.S. Application Data
(60) Provisional application No. 61/723,519, filed on Nov. 7, 2012.

(51) Int. Cl. H04W 36/14

(52) U.S. Cl. CPC H04W 36/14
USPC 370/331

(57) ABSTRACT

A method is implemented in a network executing a mobile switching center (MSC) in a global system for mobile communication (GSM) Edge Radio Access Network (GERAN). The method is for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including at least one base transceiver station (BTS).

### CROSS-REFERENCE TO RELATED APPLICATION

Cross-reference is made to a provisional U.S. patent application 61/723,519 filed on Nov. 7, 2012 and commonly owned. The cross-referenced application is incorporated herein by reference.

### FIELD OF THE INVENTION

The embodiments of the invention relate to a method and apparatus for a handover operation between base transceiver stations (BTS) in a cellular communication system. Specifically, the embodiments of the invention relate to a method and system for enabling facilitating a handover of a mobile station with a circuit switched (CS) based voice call to a packet switched (PS) based voice call using a procedure known as CS to PS Single Radio Voice Call Continuity (SRVCC) handover. The method and system avoids a requirement for the mobile station to provide a user equipment (UE) enhanced UMTS Terrestrial Radio Access Network (E-UTRAN) Radio Access Capability Information Element (IE) to the BTS supporting the CS based voice call that can diminish the quality of a voice call due to its size.

### BACKGROUND

In a cellular communication system a mobile station (MS) (also referred to as user equipment (UE)) such as a cellular phone, connects to the cellular communication system via a radio access network. Specifically, the MS connects to a base transceiver station (BTS) via a radio communication resource in global system for mobile communication GSM systems. The BTS is part of a base station subsystem (BSS) having any number of BTS and base station controllers (BSC) as well. These components connect the MS to the broader cellular communication system, which is the core network of the cellular communication system. The BSS are organized as a set of cells that service the MS in proximity to the cell, sometimes referred to as the ‘serving cell.’ However, as the MS move about they may pass out of the service area of its current serving cell thereby requiring a handover to another cell to maintain voice call continuity. Other situations can also trigger handovers of the MS.

The term ‘handover,’ as used herein, refers to the process of transferring an ongoing call or data session between channels connected to the core network. The most basic form of handover is when a voice call that is in progress is redirected from its current cell (referred to as a source cell or serving cell) to a new cell (called target cell). In terrestrial networks the source and the target cells may be different physical cell sites or the same cell site. The handover is usually performed to maintain the voice call as the MS is moving out of the area served by the source cell and entering the area served by the target cell.

Each cell in a cellular communication system is assigned a list of potential target cells, referred to as neighbor cells, the list is referred to as a neighbor list. During the voice call one or more parameters of the connection (i.e., the assigned radio channel resource) in the source cell are monitored and assessed in order to decide when a handover may be necessary. The downlink (forward link) and/or uplink (reverse link) directions may be monitored. The handover may be requested by the MS or the connected BTS when the parameters of the connection between the MS and BTS in the source cell are compared with the parameters of connections with neighbor cells indicating that a neighbor cell may provide a better connection. Examples of the parameters used as criteria for requesting a hard handover can include received signal power and received signal-to-noise ratio. In other cases the handover to a new cell associated with a different radio access technology (RAT) may be triggered simply as a result of coverage becoming available for that RAT (i.e. even when the quality of the voice call in the serving cell is still excellent).

### SUMMARY

A method of a network element implements a mobile switching center (MSC) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN). This handover is accomplished without impact on a voice call caused by sending a User Equipment (UE) E-UTRAN Radio Access Capability Information Element (IE) from a Mobile Station (MS) to a Base Station Subsystem (BSS) where the BSS includes at least one base transceiver station (BTS). The method includes receiving from a BTS in the BSS, a Handover Required message indicating CS to PS SRVCC handover and including a Forward Transparent Container having E-UTRAN frequency support information of an MS derived from measurement reports by the BTS. The MSC then generates and sends a CS to PS SRVCC handover request with the Forward Transparent Container to a target mobility management entity (MME).

Another method is implemented by a base transceiver station (BTS) in a global system for mobile communication (GSM) Edge Radio Access Network (GERAN). This method is for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including the BTS. This method establishes a CS call on a traffic channel (TCH) with the MS. Advertising of an E-UTRAN neighbor cell list to the MS is received via a broadcast control channel (BCCH). Measurement reports are received from the MS including E-UTRAN frequency measurement. E-UTRAN frequency support is determined based on E-UTRAN frequency measurement from measurement reports. CS to PS SRVCC handover is requested to an E-UTRAN when MS measurement reports indicate E-UTRAN support.

A network element implements a mobile switching center (MSC) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN). This handover is without impact on a voice call caused by sending a User Equipment (UE) E-UTRAN Radio Access Capability Information Element (IE) from a Mobile Station (MS) to a Base Station Subsystem (BSS) including at least one base transceiver station (BTS). The network element an ingress module configured to receive data traffic and an egress module configured to transmit data traffic. The network element also includes a network processor coupled to the ingress module and egress module. The network processor is configured to execute an enhanced mobile switching center (MSC) configured to receive a Handover Required message indicating CS to PS SRVCC handover and include a Forward Transparent Container from a BTS in the BSS where the Forward Transparent Container has E-UTRAN frequency support information of an MS derived from measurement reports by the BTS. The network processor generates and sends a CS to PS SRVCC handover request with the Forward Transparent Container to a target mobility management entity (MME).

A base transceiver station (BTS) can be in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN). This handover is without impact on a voice call caused by sending a User Equipment (UE) E-UTRAN Radio Access Capability Information Element (IE) from a Mobile Station (MS) to a Base Station Subsystem (BSS) including the BTS. The BTS includes a transceiver (configured to communicate with the MS and a network interface configured to transmit data traffic over the GERAN. The network processor couples to the transceiver and the network interface. the network processor is configured to execute an enhanced E-UTRAN capability detector that is configured to establish a CS call on a traffic channel (TCH) with the MS. The enhanced E-UTRAN capability detector advertises an E-UTRAN neighbor cell list to the MS via a broadcast control channel (BCCH), receives measurement reports from the MS including E-UTRAN frequency measurement, determines E-UTRAN frequency support based on E-UTRAN frequency measurement from measurement reports, and triggers a CS to PS SRVCC handover to E-UTRAN when MS measurement reports indicate E-UTRAN support.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram of one embodiment cellular communication system.

FIG. 2 is a flowchart of one embodiment of a process performed by a BTS in a BSS for determining supported E-UTRAN frequencies by an MS.

FIG. 3 is a flowchart of one embodiment of the process performed by an MSC in support of the CS to PS SRVCC handover.

FIG. 4 is a timing chart demonstrating a more comprehensive view of the handover process with each of the involved components.

FIG. 5 is a diagram of one embodiment of a network element implementing a mobile switching center (MSC).

FIG. 6 is a diagram of one embodiment of a base station such as a base transceiver station (BTS).

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations of the flow diagrams will be described with reference to the exemplary embodiment of the figures. However, it should be understood that the operations of the flow diagrams can be performed by embodiments of the invention other than those discussed with reference to the figures, and the embodiments discussed with reference to the figures can perform operations different than those discussed with reference to the flow diagrams of the figures. Some of the figures provide example topologies and scenarios that illustrate the implementation of the principles and structures of the other figures.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory). In addition, such electronic devices typically include a set of one or more processors coupled to one or more other components, such as one or more storage devices, user input/output devices (e.g., a keyboard, a touch screen, and/or a display), and network connections. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, multicasting, and/or subscriber management), and/or provide support for multiple application services (e.g., data, voice, and video). Subscriber end stations (e.g., servers, workstations, laptops, palm tops, mobile phones, smart phones, multimedia phones, Voice Over Internet Protocol (VOIP) phones, portable media players, GPS units, gaming systems, set-top boxes (STBs), etc.) access content/services provided over the Internet and/or content/ services provided on virtual private networks (VPNs) overlaid on the Internet. The content and/or services are typically provided by one or more end stations (e.g., server end stations) belonging to a service or content provider or end stations participating in a peer to peer service, and may include public web pages (free content, store fronts, search services, etc.), private web pages (e.g., username/password accessed web pages providing email services, etc.), corporate networks over VPNs, IPTV, etc. Typically, subscriber end stations are coupled (e.g., through customer premise equipment coupled to an access network (wired or wirelessly) to edge network elements, which are coupled (e.g., through one or more core network elements to other edge network elements) to other end stations (e.g., server end stations).

The disadvantages of the prior art include scenarios where a mobile station (MS) has an ongoing circuit switched (CS) call (e.g. in a 2^{nd} generation (2G) serving cell) when there may be a need for a serving base station subsystem (BSS) to trigger CS to packet switched (PS) Single Radio Voice Call Continuity (SRVCC) handover to an Enhanced Universal Mobile Telecommunications System (UMTS) Terrestrial Radio Access Network (E-UTRAN) cell based on the content of measurement reports received from that MS in the serving cell. In these scenarios, the measurement reports sent from the MS to the base station transceiver (BTS) include measurements made on one or more E-UTRAN frequencies associated with one or more E-UTRAN frequency bands. As part of the CS to PS SRVCC handover procedure the serving BSS should convey within a transparent container sent from the source BSS to the target enodeB the MS specific E-UTRA capability information. This information is referred to as User Equipment (UE) E-UTRAN Radio Access Capability Information Element (IE) conveying the E-UTRAN UE Radio Access Capability Parameters. In some further scenarios however, if the MS has only been active in the CS domain, then the BSS may not have been able to acquire the MS specific E-UTRA capability information.

The UE-EUTRAN Radio Access Capability IE supplies the target enodeB with the information required to determine the specific E-UTRAN frequencies/bands supported by the MS, which is in turn is needed to assign the correct radio interface resources in the handover command message: The UE E-UTRAN Radio Access Capability IE would ideally be assumed to be sent from the MS over the CS radio interface of the serving cell to the BTS and BSS enabling the BTS and BSS to then provide it to the target enodeB during CS to PS SRVCC handovers, however this is not practically feasible.

One challenge associated with this IE is that this IE can consist of 500 or more octets of information that must be conveyed from the MS to the BTS and BSS in the serving 2^{nd} generation (2G) cell before the BSS can trigger the CS to PS SRVCC handover. The information transferred from the MS to the network over the GSM CS radio interface to the BTS is relayed to the BSC using the Abis interface, i.e. the interface between the BTS and the BSC. This interface is based on the link access protocol for D-channel (LAPD) protocol, specific in 3GPP TS 48.056. In 3GPP TS 48.056 the maximum length of a message that can be transferred via this protocol is limited to 260 octets. This limitation basically rules out the possibility to convey the UE E-UTRAN Radio Access Capability IE over the CS radio interface.

Even if the above limitation could be removed, conveying the UE E-UTRAN Radio Access Capability IE during an ongoing CS call is prohibitive in that it could require 25 (or more) fast associated control channel (FACCH) blocks to be sent on the traffic channel (TCH) supporting the CS call since each FACCH block supports about 20 octets of payload space.

Each instance of FACCH block transmission interrupts the transmission of speech payload and the quality of speech is thereby diminished since such an interruption results in the permanent loss of the speech payload that would have otherwise been sent instead of the FACCH blocks.

The transmission of UE E-UTRAN Radio Access Capability IE needs to be accomplished over a relatively short period of time in order to ensure the BSS has the option of triggering CS to PS SRVCC handover as soon as possible after first establishing the CS call on a TCH in the serving 2G cell.

Spreading out the transmission of FACCH blocks over a larger time interval (e.g. over 10 seconds) to minimize the potential for having a concentrated and catastrophic impact on speech quality is therefore not desirable because of the increased risk it poses for the BSS being unable to perform a CS to PS SRVCC handover when needed.

These disadvantages of the prior art can be overcome by the embodiments of the present invention. The embodiments of the invention provide a solution to the disadvantage identified above based on recognizing that only a very limited subset of the information that can be conveyed by a UE E-UTRAN Radio Access Capability IE is actually needed by the serving BSS to perform a CS to PS SRVCC handover. In particular, the key information the serving BSS needs to convey to the target enodeB is the knowledge of which E-UTRAN frequencies and bands a given MS supports. Two example cases for conveying this key information are described herein. In the first case (case 1), no UE capability information (i.e. no explicit indication of supported E-UTRAN frequencies/bands) is conveyed from the serving BSS to the target enodeB during the CS to PS SRVCC handover. In the second case (case 2), a limited amount of UE capability information (i.e. based on E-UTRAN frequency related measurement reports received by the serving BSS) is conveyed from the serving BSS to the target enodeB during the CS to PS SRVCC handover. This second case gives the target enodeB greater freedom in selecting an optimal target cell (e.g. the optimum cell selection may need to factor in cell loading).

In case 1 and implementation, the serving BSS includes a so-called “Target ID” as part of the handover related information conveyed to the target enodeB (i.e. a unique cell identifier). The target enodeB is configured with the ability to map this unique cell identifier to an E-UTRAN frequency (and the corresponding E-UTRAN frequency band can then potentially be determined).

The target enodeB then selects a target cell which (a) has a frequency in the frequency band corresponding to the unique cell identifier selected by the serving BSS and (b) has overlapping coverage with the unique cell identifier selected by the serving BSS.

In case 2 and implementation, upon first establishing a CS call on a TCH in the 2G serving cell the MS uses E-UTRAN neighbor cell list information received as part of the broadcast control channel (BCCH) to determine what E-UTRAN cells can be measured and reported. The BSS can supplement the BCCH E-UTRAN neighbor cell information by sending an E-UTRAN capable MS one or more Measurement Information messages on the slow associated control channel (SACCH) of the assigned TCH thereby providing it with additional E-UTRAN cells that it may be able to measure (and therefore report).

The BSS could, for example, choose to only send Measurement Information messages to an MS that has sent one or more measurement reports that include information specific to E-UTRAN neighbor cells indicated by the BCCH. An MS can then begin sending measurement reports that may include measurements taken for the E-UTRAN frequencies/bands indicated by Measurement Information messages (i.e. in addition to reporting the E-UTRAN neighbor cells indicated by the BCCH).

Based on the content of measurement reports received from an MS the BSS can derive knowledge of what specific E-UTRAN frequencies/bands are supported (or not supported) and can therefore populate the appropriate fields within the UE E-UTRAN Radio Access Capability IE (or within a separate IE) carried within the forward transparent container conveyed from the source BSS to the target enodeB during CS to PS SRVCC handover from GERAN to E-UTRAN.

Other alternatives would be to (a) use a new field within the UE E-UTRAN Radio Access Capability IE included within the forward transparent container or (b) use a new IE within the forward transparent container to convey information about specific E-UTRAN frequencies/bands supported (or not supported) from the source BSS to the target enodeB during CS to PS SRVCC handover from GERAN to E-UTRAN. The use of either of these alternatives can implicitly indicate to the target enodeB that CS to PS SRVCC handover from a GERAN serving cell is ongoing.

The serving BSS can provide additional information in the forward transparent container (such as the GERAN capabilities of the MS) which may be beneficial to the target enodeB. Once the key information is derived (or otherwise obtained without the serving BSS receiving the UE-EUTRA-Capability IE directly from the MS over the CS radio interface of the serving 2G cell), the serving BSS will then be able to trigger CS to PS SRVCC handover for those MS that support operation within E-UTRAN cells.

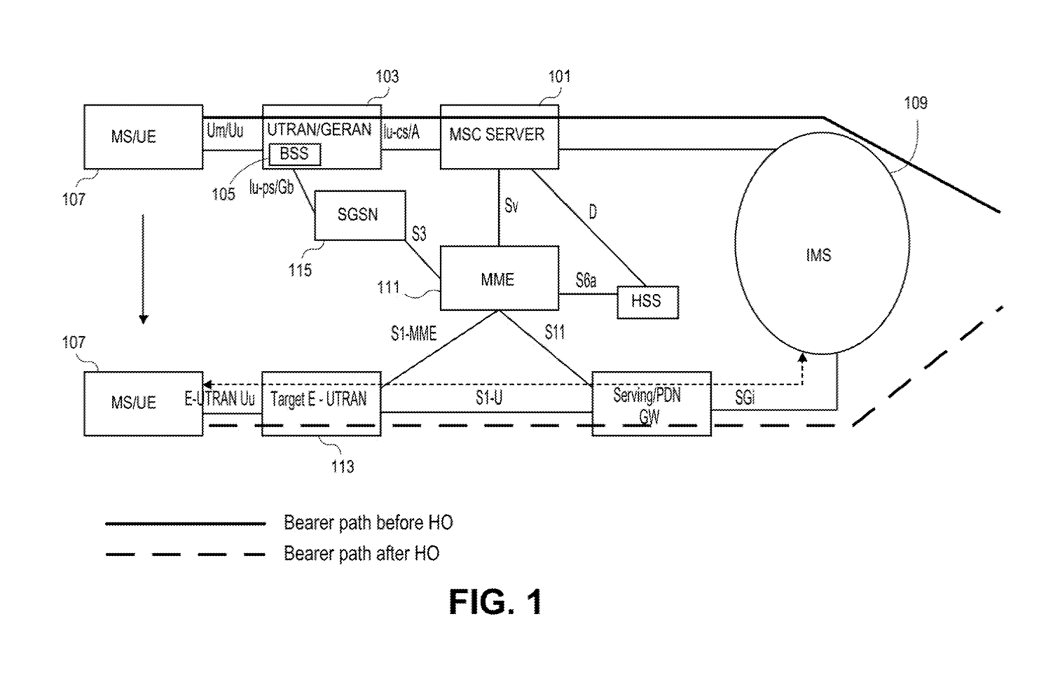

FIG. 1 is a diagram of one embodiment cellular communication system. The illustrated cellular communication system is provided by way of example and not limitation. One skilled in the art would understand that it is a simplified representation for sake of clarity in understanding the principles and structure relevant to the embodiments of the invention. These principles and structures can be applied to a cellular communication system with any similar or expanded set of components and configuration.

In one embodiment, the cellular communication system services a set of mobile stations 107. A set, as used herein, refers to any positive whole number of items including one item. In the illustrated example, a single MS is shown transitioning from an UTRAN or GERAN to an E-UTRAN (i.e., from a 2G connection to a 4G connection).

The MS 107 is initially connected to a BSS 105 within the UTRAN or GERAN 103. The MS 107 communicates with the BSS 105 via an Um or Uu interface. The BSS 105 can include any number of BTS and BSC. Similarly, the UTRAN or GERAN 103 can include any number of BSS 105. The UTRAN or GERAN 103 connects the MS 107 with an Internet Protocol Multimedia Subsystem (IMS) 109 or similar core network that provides inter-communication with other parts of the cellular communication system as well as connectivity with systems outside the cellular communication system.

In the example embodiment, the UTRAN or GERAN 103 is connected with an E-UTRAN via a serving general packet radio service (GPRS) support node (SGSN) 115, a mobile switching center (MSC) server 101, a mobile management entity (MME) 111, and similar components. The SGSN 115 is responsible for the delivery of data packets from and to the MS within its geographical service area for the PS domain. The SGSN can perform packet routing and transfer, mobility management (i.e., attachment, detachment and location management), logical link management, and authentication and charging functions.

The MSC server 101 is a primary service delivery node that is responsible for routing voice calls, short message service (SMS) and similar services for the CS domain. The MSC can assist in the establishment and release of end-to-end connections, handle handover processes for calls and plays a role in charging and accounting. The MME 111 is a control node for a long term evolution (LTE) network. It is responsible for MS tracking, bearer activation or deactivation processes and choosing a serving gateway for an MS during handover operations. The MME can also assist in authentication services in conjunction with a home subscriber service (HSS).

A target E-UTRAN is the fourth generation (4G) network into which a MS 107 is being transferred in the scenarios contemplated for the embodiments described herein. The target E-UTRAN can include a set of enodeBs that handle connections with the MS that are connected to the E-UTRAN. The E-UTRAN 113 can be connected to the IMS 109 through a serving public data network (PDN) gateway (GW).

One skilled in the art would understand that the cellular communication system includes additional components and functions that have not been illustrated for sake of clarity. The embodiments described herein below are compatible with any similar or analogous network architecture involving a handover from a system with the limitations discussed herein above to another system such as an E-UTRAN.

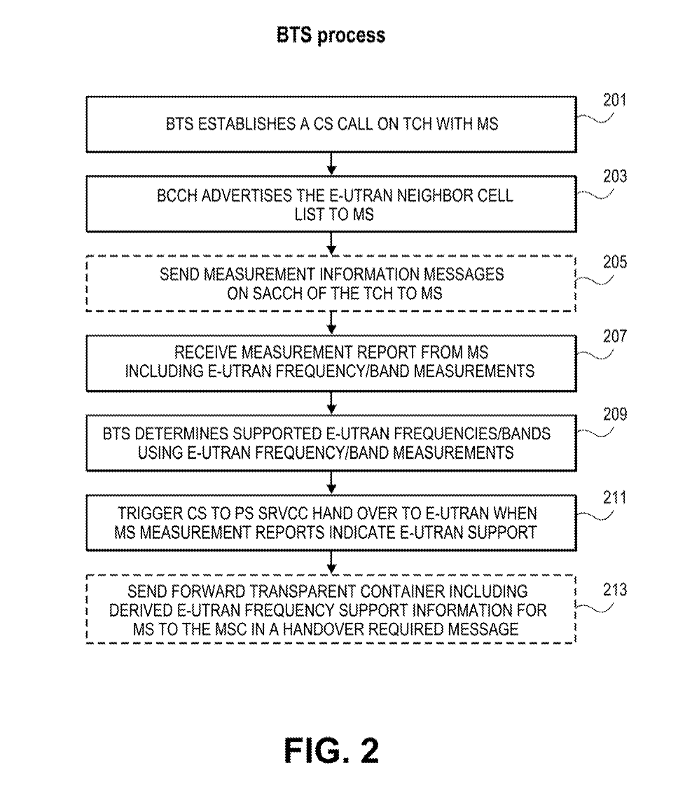

FIG. 2 is a flowchart of one embodiment of a process performed by a BTS in a BSS for determining supported E-UTRAN frequencies by an MS. In one embodiment, the process begins with the initial establishment of a call, specifically a CS call on a TCH with the MS (Block 201). The call will be transferred in response to the MS having E-UTRAN support compatible with neighboring cells. To determine the support, the MS learns of the neighbor E-UTRAN cells by the BCCH advertisement of the E-UTRAN neighbor cell list to the MS (Block 203) or by measurement information messages it receives from the BTS on the SACCH (205). This prompts the MS to measure the signal, frequency, noise or similar parameters of each of the listed neighbor cells.

The results of the measurements are sent to the BTS in the form of measurement reports from the MS, which include E-UTRAN frequency or band support measurements (Block 207). The MS will only report measurements for frequencies or bands that it is capable of using. Even if the neighbor cells are not good candidates for a handover due to the measurement information returned, the BTS learns of the supported E-UTRAN frequencies or bands where the measurement reports do not return a null or empty value for a given E-UTRAN frequency or band (Block 209).

The BTS can trigger a CS to PS SRVCC handover where the measurement reports indicate support for E-UTRAN and that the parameters indicate sufficient signal strength, noise thresholds or similar requirements (Block 211). This derived E-UTRAN supported frequencies can be included in the Forward Transparent Container (using the UE E-UTRAN Radio Access Capability IE or some other IE/field for conveying this derived information) sent by the BTS to the MSC and the target MME (Block 213). The forward transparent container with the derived E-UTRAN frequency support for the MS is included within a Handover Required message sent from the BTS to the MSC which then triggers the MSC to perform a CS to PS SRVCC handover. This new scenario for conveying MS capability information differs from a legacy scenario where the MS is able to provide a full UE E-UTRAN Radio Access Capability IE in the Forward Transparent Container (even when it has not received this IE from the MS over the CS radio interface) in that using the legacy scenario would mean the UE E-UTRAN Radio Access Capability IE indicates a lack of support for all neighbor E-UTRAN cells rather than indicating support for a subset of the E-UTRAN cells (if any at all). In other words, allowing a new scenario wherein the serving BTS can send a Forward Transparent Container that includes an incomplete (or even an empty) UE E-UTRAN Radio Access Capability IE is not in compliance with the legacy standard requirements for this IE to provide full information.

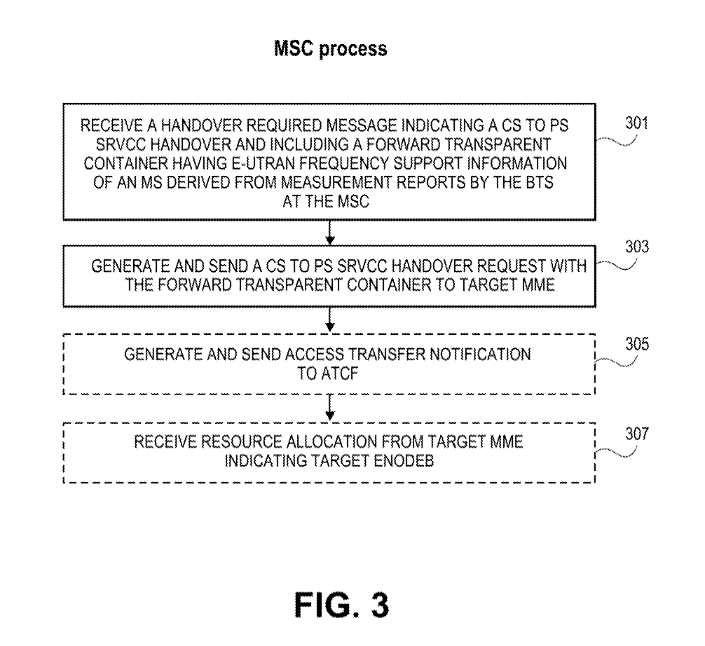

FIG. 3 is a flowchart of one embodiment of the process performed by an MSC in support of the CS to PS SRVCC handover. The MSC is able to utilize the E-UTRAN supported frequencies and bands derived by the BTS or BSS to effect the handover to a target MME and thereby handover the MS to the E-UTRAN. In one example embodiment, the process begins at the MSC when it receives a Handover Required message including a Forward Transparent Container having E-UTRAN frequency support information of an MS (or set of MS) that is derived from measurement reports or similar information by the BTS (Block 301). The Forward Transparent Container is included within a Handover Required message received from the BTS which causes the MSC to trigger CS to PS SRVCC handover.

The process continues when the MSC generates and sends a CS to PS SRVCC handover request including the Forward Transparent Container to a target MME (Block 303). The target MME can be determined based on the reported parameters such as E-UTRAN frequency support or similar information.

The MSC can also generate and send an Access Transfer notification to the Access Transfer Control Function (Block 307). The ATCF assists in the call transfer by allocating resources to support the call transfer. The MSC then receives resource allocation information from the target MME indicating connection parameters for the MS to enable it to connect to a target enodeB or similar component of the E-UTRAN. The information can include port, frequency, and similar information needed for establishing the connection with the E-UTRAN for the MS (Block 209).

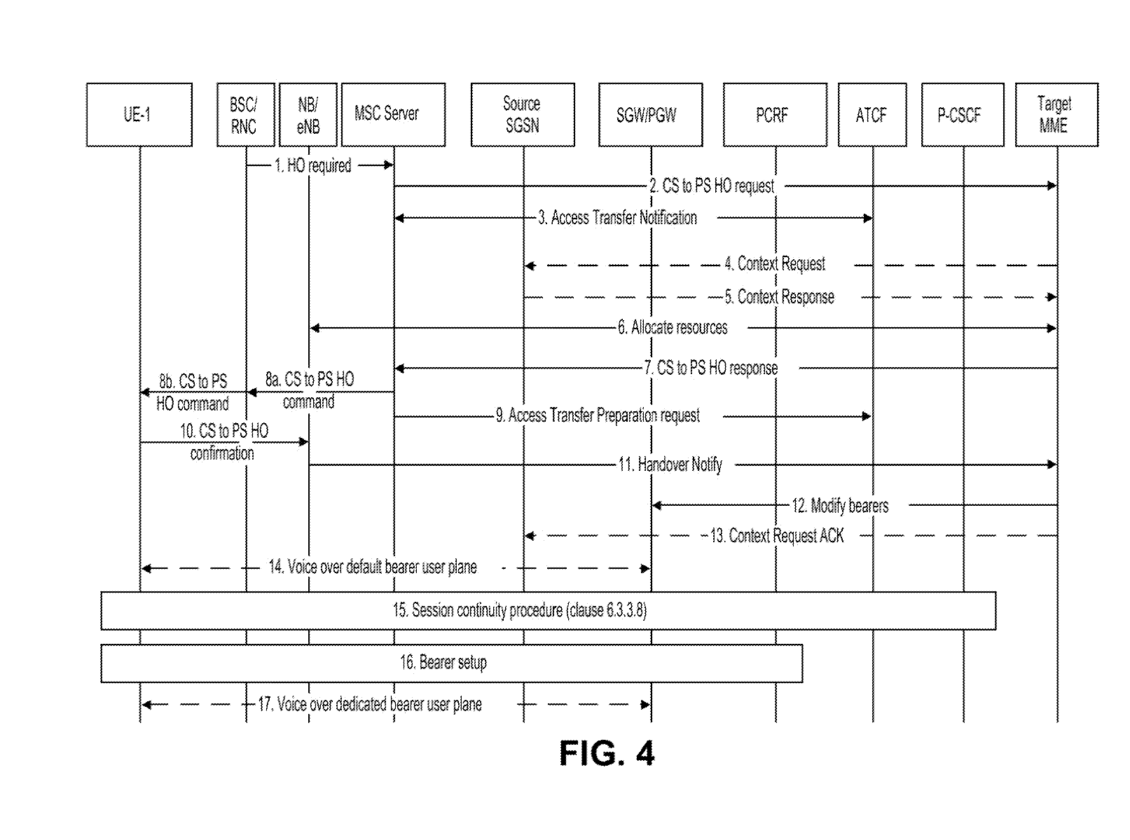

FIG. 4 is a timing chart demonstrating a more comprehensive view of the handover process with each of the involved components. The timing diagram is utilized to illustrate both cases or implementations discussed herein above. In the example embodiment that is illustrated, only the handover process is shown, not the process of determining E-UTRAN support by a MS.

In the example, at step (1) the RNC/BSC sends a handover required message to the MSC Server including an indication that this handover is for reverse SRVCC (rSRVCC) also known as CS to PS SRVCC. If the MSC Server is the target MSC, it forwards the handover required message to the anchor MSC Server. The source (i.e., serving) BSC uses the content of measurement reports to determine E-UTRAN frequencies and bands supported (or not supported) by the MS. The detection of these supported E-UTRAN frequencies can trigger CS to PS SRVCC handover to E-UTRAN where this information is conveyed from the source BSS to the target enodeB in the forward transparent container. The source BSS may also choose to not include any information regarding the E-UTRAN frequencies and bands supported by the UE in which case the target enodeB uses the target cell id (included the forward transparent container) to make a determination of an appropriate E-UTRAN frequency to allocate for the purpose of CS to PS SRVCC handover.

The MSC Server sends an SRVCC CS to PS handover request to the Target MME at step (2). If required, the IMSI is provided for identifying the MS. The MSC Server sends an Access Transfer Notification to the ATCF, e.g. a Session Initiation Protocol (SIP) re-INVITE or INVITE message at step (3), which indicates to the ATCF that it should prepare for the transfer of media to PS. The ATCF allocates media ports on the access transfer gateway (ATGW). The media ports and codecs allocated by the ATCF are provided to the MSC Server in the response message. This step is independent of step 2. The ATCF retrieves the ports/codecs received from the MS in its IMS registration. The ATCF is able to correlate the IMS registration made by the UE and the one made by the MSC Server on behalf of the MS for instance based on the controller of the Mobile Subscription Integrated Serviced Digital Network (C-MSISDN) or on the international mobile station equipment identity (IMEI) derived instance-identifier used by both those registrations. The Access Transfer Notification message could e.g., be implemented using an INVITE or other appropriate message. It is left open ended for this stage to decide on appropriate message.

In the fourth step, if the MME has no UE context it sends Context Request using Packet-Temporary MS Identifier (P-TMSI) and Routing Area Identity (RAI) to find the old SGSN. In the fifth step, the SGSN respond with a Context Response message including all UE contexts. In the sixth step, the target MME allocates resources in E-UTRAN, such as particular frequencies, equipment, ports or similar resources. In the seventh step, an SRVCC CS to PS handover response is returned from the target MME to the MSC Server. In the eighth step, the MSC Server sends a handover required acknowledgment (Ack) to the GERAN, possibly via the target MSC, and the GERAN sends a handover command to the MS, indicating CS to PS handover. The MSC Server also includes in that message the IP address/ports and selected codec for the Access Transfer Gateway (ATGW).

In the ninth step, in the case where the ATCF has media anchored in ATGW, the MSC Server sends an Access Transfer Preparation Request, e.g. a SIP re-INVITE or PRACK message, to the ATCF to trigger the ATCF/ATGW to have the media path switched to the IP address/port of the UE on the target access. In cases of an ATCF without media anchored in ATGW, MSC Server sends an Access Transfer Preparation Request to ATCF and the media path between ATCF/ATGW and the MSC Server/MGW is to be established.

In the tenth step, the MS or UE sends a handover confirmation to the target enodeB. In the eleventh step, the enodeB sends a handover notification to the MME. In the twelfth step, the MME sends a Modify Bearer Request to the SGW, which is forwarded to the PGW to update PS bearer contexts. In the thirteenth step, the MME sends an acknowledgment to the Context Response to the SGSN. In the fourteenth step, the voice media is started directly to be sent to target enodeB. During a short period of time prior the radio access technology (RAT) has been changed and the new bearer has been established, the media will be sent over the default bearer.

In the fifteenth step, the MS/UE initiates the session continuity procedures towards the ATCF. As a result of the session continuity procedures, the bearer setup is performed (initiated by the Proxy-Call Session Control Function (P-CSCF). Thereafter, the voice media is sent in the dedicated bearer. The example context and implementation are provided by way of example and not limitation. One skilled in the art would understand that other components and processes can also be implemented consistent with the principles and structures of the embodiments.

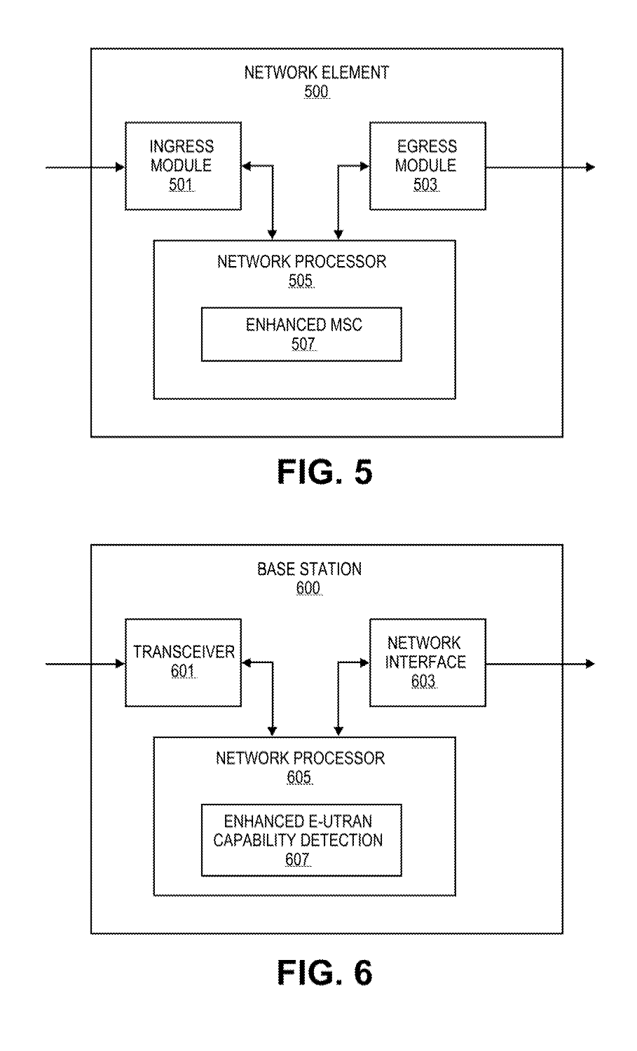

FIG. 5 is a diagram of one embodiment of a network element implementing a mobile switching center (MSC). The illustrated network element is provided by way of example and not limitation. The network element 500 can include additional components and functions, however, such components have been omitted for sake of clarity.

In one embodiment, the network element 500 includes a set of ingress modules 501 and egress modules 503. The ingress modules 501 and egress modules 503 receive voice and data communications and transmit voice and data communication respectively. These ingress modules 501 and egress modules 503 can be line cards or similar network interface components that enable communication with a BSS, GERAN and other components of the cellular communication system.

In one embodiment, the network element 500 includes a set of network processors 505 that execute an enhanced MSC 507. The enhanced MSC implements the processes described herein above in relation to FIG. 3 and the applicable MSC functions described with relation to FIG. 4. These functions can be implemented in a single module or in any distributed set of modules where the modules are code or firmware executed by the network processor 505. The network processor 505 can be any type of general processor or application specific integrated circuit.

FIG. 6 is a diagram of one embodiment of a base station. The illustrated base station is provided by way of example and not limitation. The base station 600 can include additional components and functions, however, such components have been omitted for sake of clarity.

In one embodiment, the base station 600 includes a set of transceivers 601 and network interfaces 603. The transceivers 601 and network interfaces 603 receive voice and data communications and transmit voice and data communication respectively. The transceiver 601 connects to the MS via a spread spectrum radio communication. The network interface 603 can be line cards or similar network interface components that enable communication with an MSC, GERAN and other components of the cellular communication system.

In one embodiment, the base station 600 includes a set of network processors 605 that execute an E-UTRAN Capability Detection module 607. The enhanced E-UTRAN Capability Detection module 607 implements the processes described herein above in relation to FIG. 2 and the applicable BSS or BST functions described with relation to FIG. 4. These functions can be implemented in a single module or in any distributed set of modules where the modules are code or firmware executed by the network processor 605. The network processor 605 can be any type of general processor or application specific integrated circuit.

Thus, a method, system and apparatus for a process for a CS to PS SRVCC handover that utilizes UE E-UTRAN Radio Access Capability IE information, specifically supported E-UTRAN frequencies, that has been derived by the BTS from measurement reports and similar information has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method in a network element implementing a mobile switching center (MSC) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including at least one base transceiver station (BTS), the method comprising the steps of:
receiving (301) from a BTS in the BSS, a Handover Required message indicating CS to PS SRVCC handover and including a Forward Transparent Container having E-UTRAN frequency support information of an MS derived from measurement reports by the BTS; and
generating and sending a CS to PS SRVCC handover request with the Forward Transparent Container to a target mobility management entity (MME).

2. The method of claim 1, further comprising the step of:
generating and sending an access transfer notification to an Access Transfer Control Function (ATCF).

3. The method of claim 1, wherein the handover request indicates that the handover is for reverse SRVCC.

4. The method of claim 1, further comprising:
receiving resource allocation from the target MME indicating a target enodeB.

5. A method implemented by a base transceiver station (BTS) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including the BTS, the method comprising the steps of:
establishing a CS call on a traffic channel (TCH) with the MS;
advertising E-UTRAN neighbor cell list to the MS via a broadcast control channel (BCCH);
receiving measurement reports from the MS including E-UTRAN frequency measurement;
determining E-UTRAN frequency support based on E-UTRAN frequency measurement from measurement reports; and
triggering a CS to PS SRVCC handover to E-UTRAN when MS measurement reports indicate E-UTRAN support.

6. The method of claim 5, further comprising the steps of:
sending measurement information messages on a slow associated control channel of the TCH to the MS.

7. The method of claim 5, further comprising the steps of:
sending a forward transparent container including derived E-UTRAN frequency support information for the MS to a mobile switching center (MSC) of the GERAN within a Handover Required message.

8. The method of claim 7, wherein the derived E-UTRAN frequency support information is included within the UE E-UTRAN Radio Access Capability IE present within the Forward Transparent Container.

9. A network element implementing a mobile switching center (MSC) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including at least one base transceiver station (BTS), the network element comprising:
an ingress module configured to receive data traffic;
an egress module configured to transmit data traffic; and
a network processor coupled to the ingress module and egress module, the network processor to execute an enhanced mobile switching center (MSC) configured to receive a Handover Required message indicating CS to PS SRVCC handover and including a Forward Transparent Container from a BTS in the BSS where the Forward Transparent Container has E-UTRAN frequency support information of an MS derived from measurement reports by the BTS and to generate and send a CS to PS SRVCC handover request with the Forward Transparent Container to a target mobility management entity (MME).

10. The network element of claim 9, wherein the network processor is further configured to generate and send an access transfer notification to an Access Transfer Control Function (ATCF).

11. The network element of claim 9, wherein the handover request indicates that the handover is for reverse SRVCC.

12. The network element of claim of claim 9, wherein the network processor is further configured to receive resource allocation from the target MME indicating a target enodeB.

13. A base transceiver station (BTS) in a global system for mobile communication (GSM) Edge Radio Access Network (GERAN) for managing a circuit switched (CS) to packet switched (PS) single radio voice call continuity (SRVCC) handover to an Evolved Universal Terrestrial Radio Access Network (E-UTRAN) without impact on a voice call caused by sending a User Equipment (UE) E-UTRAN Radio Access Capability Information Element (IE) from a Mobile Station (MS) to a Base Station Subsystem (BSS) including the BTS, the BTS comprising:
a transceiver configured to communicate with the MS;
a network interface configured to transmit data traffic over the GERAN; and
a network processor coupled to the transceiver and the network interface, the network processor to execute an enhanced E-UTRAN capability detector that is configured to establish a CS call on a traffic channel (TCH) with the MS, to advertise an E-UTRAN neighbor cell list to the MS via a broadcast control channel (BCCH), to receive measurement reports from the MS including E-UTRAN frequency measurement, to determine E-UTRAN frequency support based on E-UTRAN frequency measurement from measurement reports, and to trigger a CS to PS SRVCC handover to E-UTRAN when MS measurement reports indicate E-UTRAN support.

14. The BTS of claim 13, wherein the enhanced E-UTRAN capability detector is further configured to send measurement information messages on a slow associated control channel of the TCH to the MS.

15. The BTS of claim 13, wherein the enhanced E-UTRAN capability detector is further configured to send a Forward Transparent Container including derived E-UTRAN frequency support to a mobile switching center (MSC) of the GERAN within a Handover Required message

16. The BTS of claim 15, wherein the derived E-UTRAN frequency support information is included within the User Equipment (UE) E-UTRAN Radio Access Capability IE present within the Forward Transparent Container.
